(19) United States
(12) Patent Application Publication
(10) Pub. No.: US 2003/0110686 A1
(43) Pub. Date: Jun. 19, 2003

(54) Plant support system

(76) Inventors: Bernard Dougal McDowell, Wimbledon, NSW (AU); Jason Mclachlan, Bathurst, NSW (AU); James Leahey, Bathurst, NSW (AU)

Correspondence Address: Abelman Frayne & Schwab, 150 East 42nd Street, New York, NY, 10017-5612, US

(21) Appl. No.: 10/239,802

(22) PCT Filed: Mar. 26, 2001
(86) PCT No.: PCT/AU01/00334

(30) Foreign Application Priority Data
Mar. 24, 2000 (AU) PQ 6569
Mar. 2, 2001 (AU) 24880/01

(51) Int. Cl. A01G 17/06; A01G 17/14

(52) U.S. Cl. 47/46

(57) ABSTRACT

A support (13) for plants comprises of two flanges (14, 15) between which extends a portion (10) and a spacer or top portion (102). The support (13) allows plants to grow adjacent to a wall or fence (17) without suffering the effects of excess heat.

### TECHNICAL FIELD

This invention relates to fencing and more particularly to means for supporting plants adjacent to but spaced from a fence.

For the sake of convenience, the invention will be described in relation to sheet metal fences but it is to be understood that it is not limited thereto as it may be applied to other fences such as wooden fences and other structures such as walls.

### BACKGROUND OF THE INVENTION

Sheet metal fences are widely used but suffer from the disadvantage that it is difficult to grow plants against them because the metal readily absorbs heat from the sun. For example, in certain circumstances it is not practicable to grow climbing plants against a metal fence because of the adverse effect of the heat of the fence on the climbing plants.

Sheet metal fences are not particularly aesthetic and home owners do wish that they could have plants on or against such fences to at least partially obscure them as can be done with wooden fences. There is, therefore, a need for means for supporting plants adjacent to sheet metal fences.

### SUMMARY OF THE INVENTION

According to one particular aspect of the invention there is provided a plant support comprising:

top and bottom flanges, aligned in a common vertical plane;

the bottom flange supporting a lower end of an elongated member;

the elongated member extending from the lower flange to one end of a spacer;

the spacer extending between an upper portion of the elongated member and the upper flange.

Preferably, the elongated member is formed from identical interlocking plastic sections.

The elongated members at each end of the system may have a brace between its outer most portion and the fence with the brace extending from the elongated member in the general direction of the tension generated by the wires. A turnbuckle may be incorporated into each wire to facilitate tensioning of the wires.

In other embodiments, the bottom flange is integral with a foot, the foot having means for receiving the lower end of the elongated member.

In order that the invention may be more readily understood and put into practical effect, reference will now be made to the accompanying drawings in which:—

### BRIEF DESCRIPTION OF THE DRAWING FIGURES

FIG. 1 is a perspective view of an elongated member for a plant support system according to one embodiment of the invention,

FIG. 2 is an enlarged view of an elongated member connected to a fence post,

FIG. 3 is a schematic top plan view of one end of a plant support system with an angle bracket and turnbuckle.

FIG. 4 is an enlarged view of portion of the elongated member showing the grommets in place,

FIG. 5 is an enlarged view of the turnbuckle shown in FIG. 3,

FIG. 6 is an enlarged view of the brace shown in FIG. 3,

FIGS. 7 to 12 show various modifications of the elongated member shown in FIG. 1,

FIG. 13 is a side elevation of an embodiment of the invention,

FIG. 14 depicts front and side elevations of another embodiment of the invention,

FIG. 15 illustrates front, back, side and top views of the top portion or spacer shown in FIG. 14,

FIG. 16 depicts a partially cross-section top view of the invention illustrating how it may be attached to a fence post,

FIG. 17 depicts front, side and top elevations of the adaptor depicted in FIG. 16,

FIG. 18 illustrates front, side and bottom views of the foot depicted in FIG. 14,

FIG. 19 depicts front, side, back, top and bottom views of a segment of the type depicted in FIG. 14, the Fig. also illustrating a cross-section and a detail of the keyholes, and

FIG. 20 is a perspective view of three plant supports which are laced together.

### BEST MODE AND OTHER EMBODIMENTS OF THE INVENTION

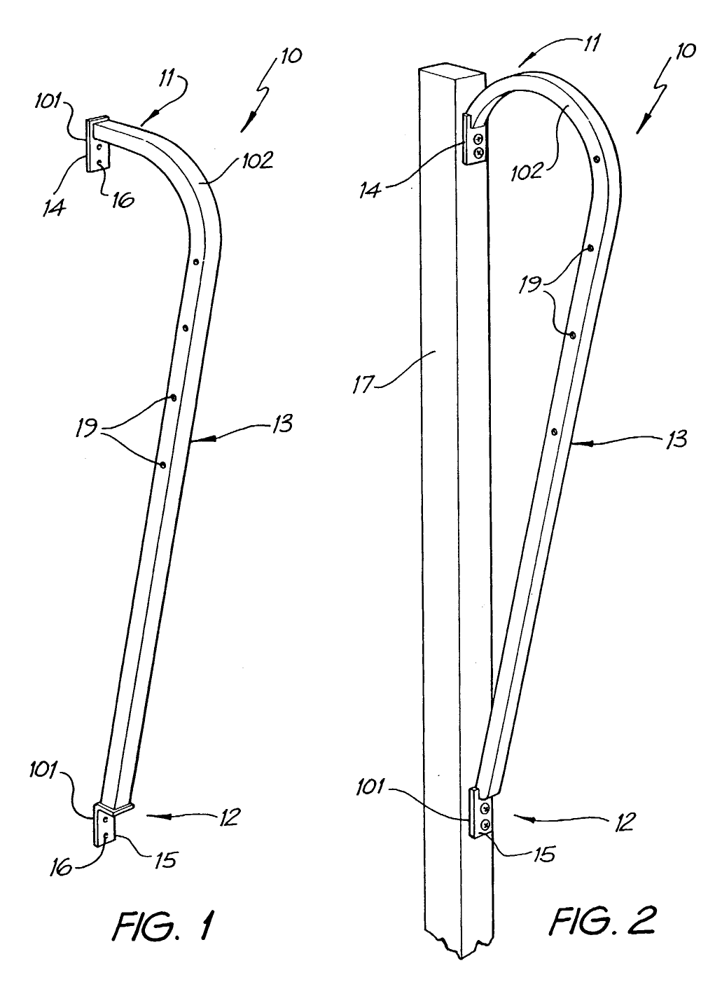

The plant support means 10 shown in FIG. 1 includes a major portion 13 which in this instance is formed from 25 mm by 25 mm square cross-section steel tube but of course the member may be formed from any suitable material of any suitable configuration. The support 10 has a top portion 11, a bottom portion 12 and a major portion 13 therebetween. At the top end portion 11 there is a mounting flange 14 which may be formed from the material of the elongated member or by an additional component. A similar mounting flange 15 or foot is provided at the bottom end portion 12. Each of the flanges 14 and 15 have apertures 16 for receiving screws or other fasteners by which the member 10 is secured to a fence post 17 as shown in FIG. 2.

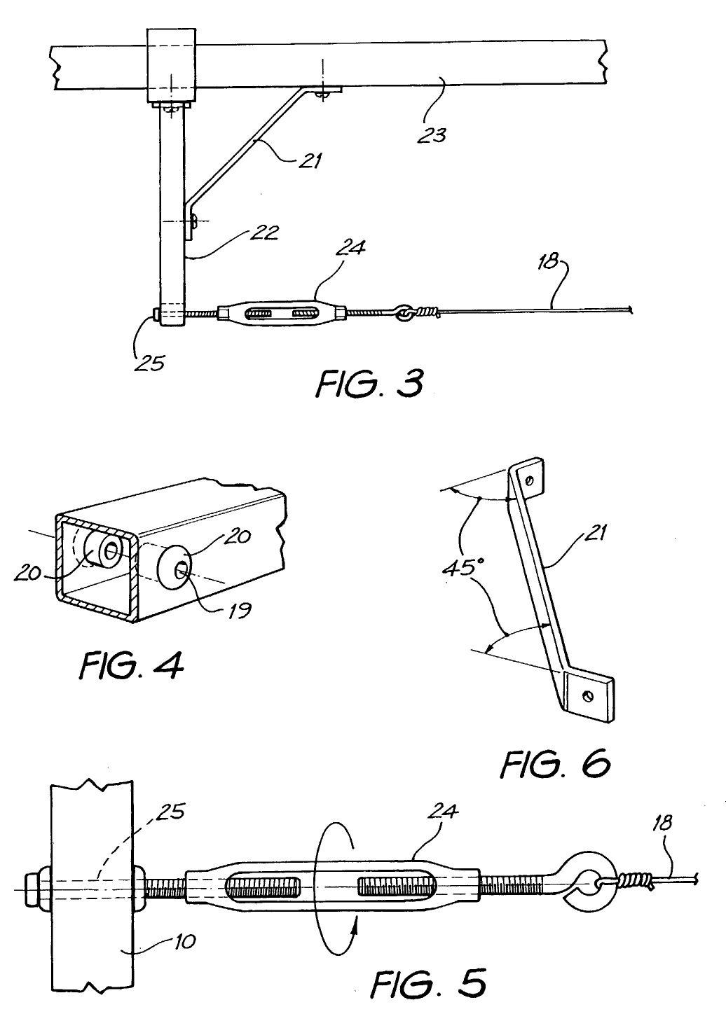

As can be seen in FIGS. 1 and 2, the flat faces 101 of the flanges 14 and 15 are more or less parallel and in a common vertical plane to accommodate mounting to the face of the wall, fence or fence post 17. The major straight portion 13 of the elongated member 10 is disposed so that it inclines away from the fence post 17. The upper end of the major portion 13 is furthest from the post and the lower end is closest. A support 10 is secured to each of a run of fence posts and the members 10 are interconnected by horizontal lines, strings or wires 18. To this end, each member 10 may have a plurality of spaced apart transverse through apertures 19 perforating in its side faces, there being four such pairs of apertures in the example of the elongated member of FIG. 2. In this instance, a grommet 20 is placed in each aperture 19 as shown in FIG. 4. The wires or lines (such as twine, string or monofilament) 18 may be secured to the elongated members 10 by any convenient means.

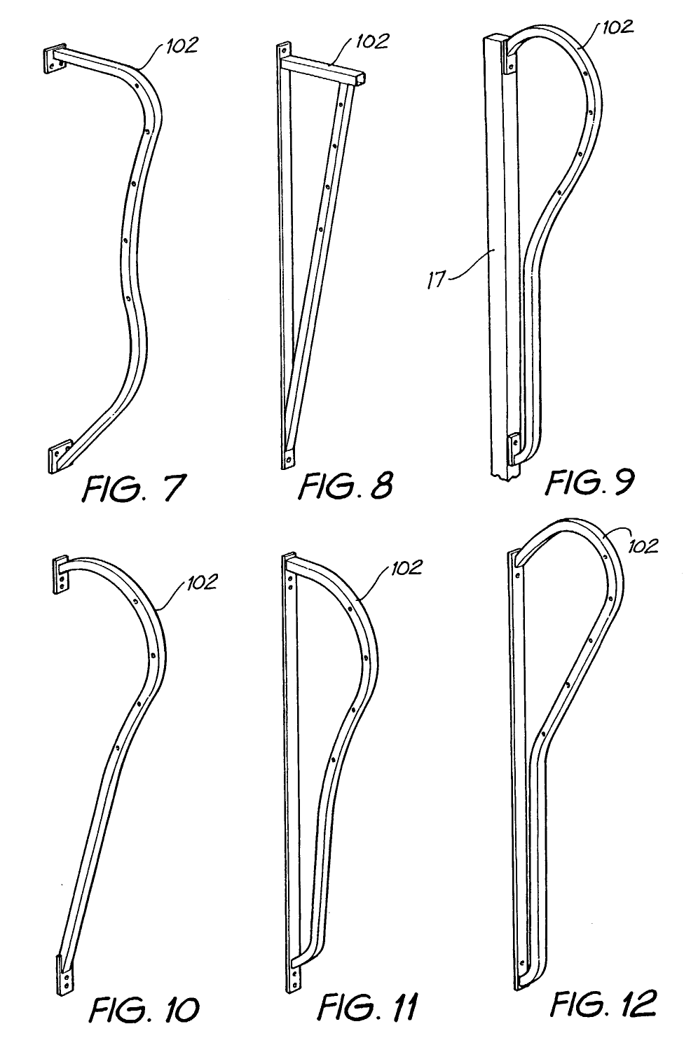

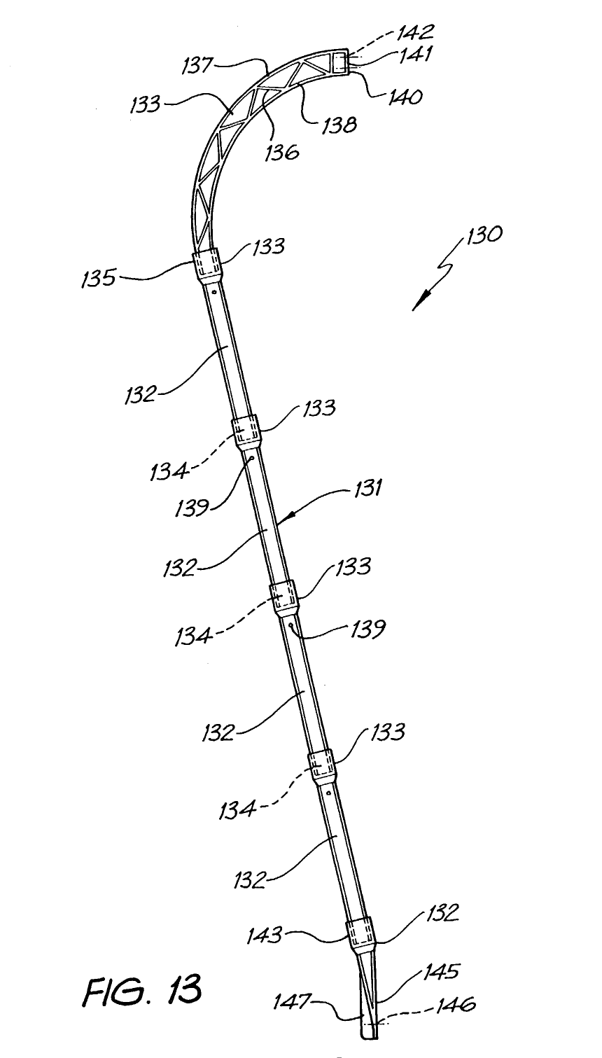

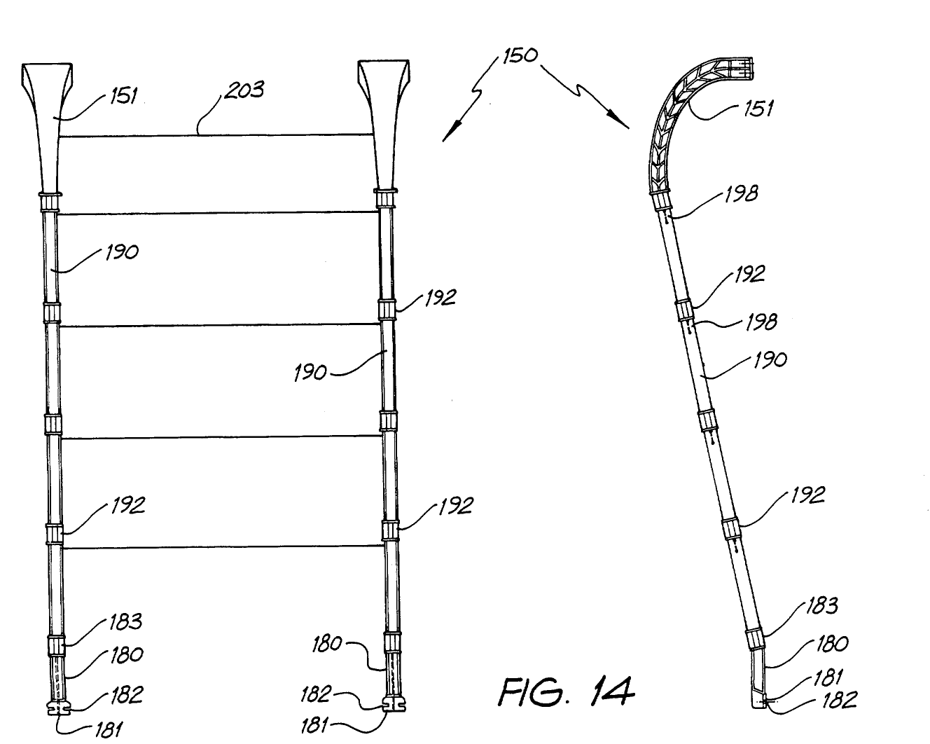

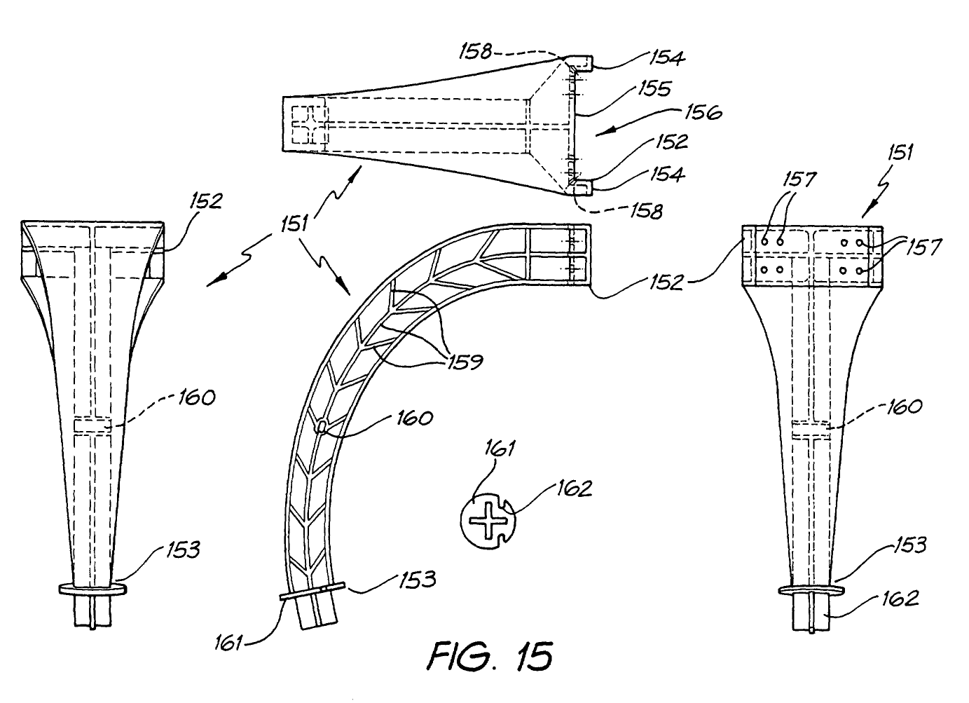

In preferred embodiments, the position and angle of the elongated member 10 with respect to the foot 15 allows the bottom of the member 10 to be positioned very close to the fence or post to which it is attached. A preferably curved top portion or spacer 102 spaces the top of the member 10 away from he fence or post by about 200 to 350 mm. The portion is preferably straight, but may be curved as shown in FIGS. 7 and 9 to 12. As shown in FIG. 9, the portion 13 remains generally parallel to the fence post 17 until about its mid-point 103.

The support 10 shown in top view in FIG. 3 is, for example, at the left hand end of a row of plant supports 10. An angle brace 21 (shown enlarged in FIG. 6) extends between the inner face 22 of the member 10 and the fence rail 23. Preferably the end of each wire 18 is connected to one end of the body of a turnbuckle 24. The other end of the turn buckle 24 is connected to a threaded retainer member 25 which is attached to a member 10 as shown in FIG. 5. Rotation of the turn buckle 24 tensions the wire 18.

The elongated portion 13 may be of any convenient shape and variations of the shape are shown in FIGS. 7 to 12.

As shown in FIG. 13 a plant support may be manufactured from a polymer, such as an injection moulded plastic. In this example, the elongated portion 131 is supported between a foot 132 and a curved top portion 133. The elongated portion 131 is fabricated from four or more identical segments 132. The upper extent of each segment 132 is in the form of a ferrule, flange or cup 133 which is adapted to receive and secure the lower extent 134 of an adjacent segment 132. Each segment 132 also includes a through opening 139. The uppermost ferrule 135 receives the lower terminal portion of the top portion 133. The top portion 133 forms a curve which spaces the upper ferrule 135 from the fence post by about 200-350 mm. The top portion 133 is given structural rigidity by forming it as a curved I beam. For additional rigidity, intermediate ribs 136 are provided and extend between the upper and lower flanges 137, 138 of the beam.

The top portion 133 also includes an integral mounting flange 140 with laterally extending projections 141 in which are provided through holes 142 for attaching the flange 140 to a wall, fence or fence post.

The foot 132 functions as both a stake or a mounting flange. The upper portion of the foot is formed as a ferrule 143 for receiving a lower end 134 of a section 132. The lower portion of the foot 132 forms a mounting flange 145 which lies generally in the same plane as the upper flange 140. The flange 145 is inclined with respect of the long axis of the ferrule 143 and the elongated portion 131 and includes through openings 146 which facilitate attachments to the wall, fence or fence post. The flange 145 may be reinforced by a perpendicular rib 147.

As shown in FIG. 14, a further embodiment of the invention 150 provides a modular and injection moulded construction which features enlarged flanges in the top portion or spacer 151. As shown better in FIG. 15, the flange 152 of the top portion or spacer 151 flares outwardly from the bottom joint 153 to the bracket-like mounting flange 152. The mounting flange 152 incorporates ears 154 which extend forward of the flat mounting face 155. The gap between the ears 154 is about 90 mm which allows the gap 156 to receive a similarly sized fence post. It will be understood that the width of the gap 156 may be fabricated to suit any particular size post. The mounting face 155 includes various through openings 157 which are perpendicular to the face 155. The flange 152 also incorporates openings 158 which are formed at an angle with respect to the face 155. The top portion or spacer 151 is optionally formed with reinforcing ribs 159 which provide rigidity and structural strength. A transverse through opening 160 is located between the bottom joint 153 and the mounting flange 152. The lower abutment surface 161 incorporates one or more slots 162 which facilitate lacing, as will be explained. The bottom joint 153 comprises a male cruciform member 162 located below the abutment surface 161.

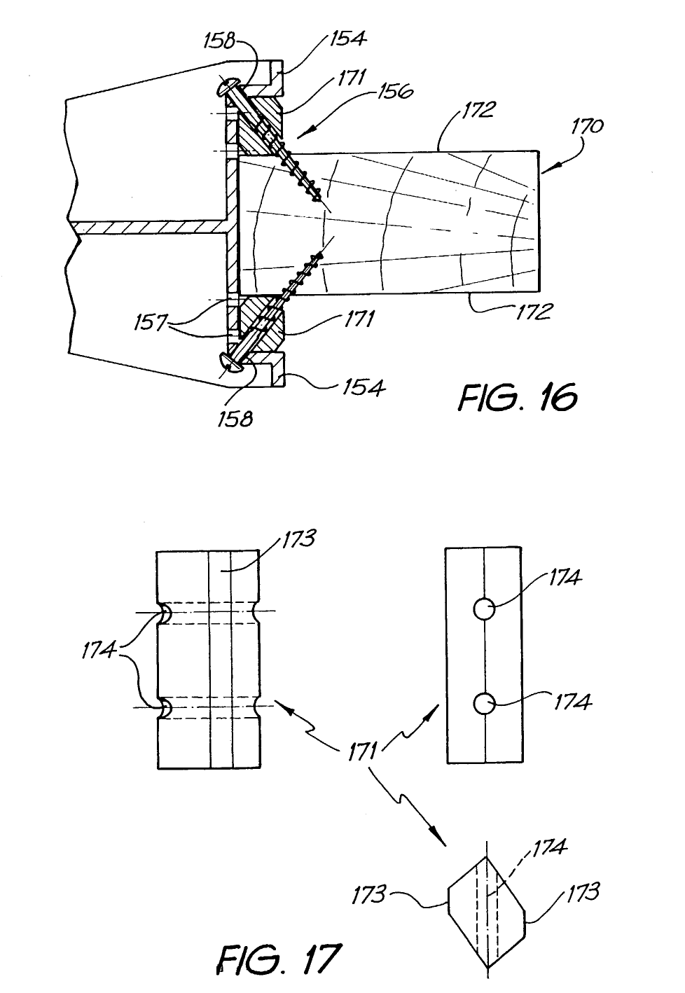

While a top portion of the type depicted in FIG. 15 is ideally suited for a fence post whose width is the same as the width of the gap 156, this same structure may be used with posts of lesser width. As shown in FIG. 16, a narrower fence post 170 is accommodated by locating it centrally of the gap 156 and securing it in place utilising spacers 171. The spacers fit between the post 170 and the ears 154. In this example, screws pass through the angled openings 158, through the openings in the spacers 171 and enter the post 170 through the side faces 172.

As shown in FIG. 17, the spacers 171 comprise a generally rectangular solid with opposed bevelled corners 173 and a pair of through openings 174.

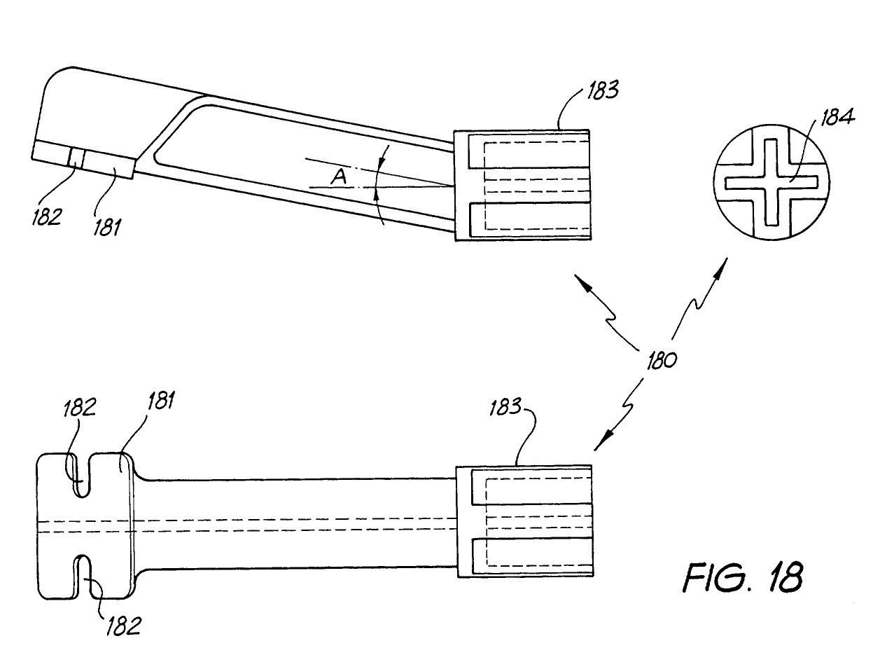

As shown in FIG. 18, the foot 180 (first shown in FIG. 14) comprises a mounting flange 181 featuring opposed slots 182. The top joint 183 is offset by an angle A with respect to the long axis of the foot 180. The top joint 183 comprises a socket or female member having a cruciform or other shaped recess 184 adapted to receive the lower extremity of the elongated portion.

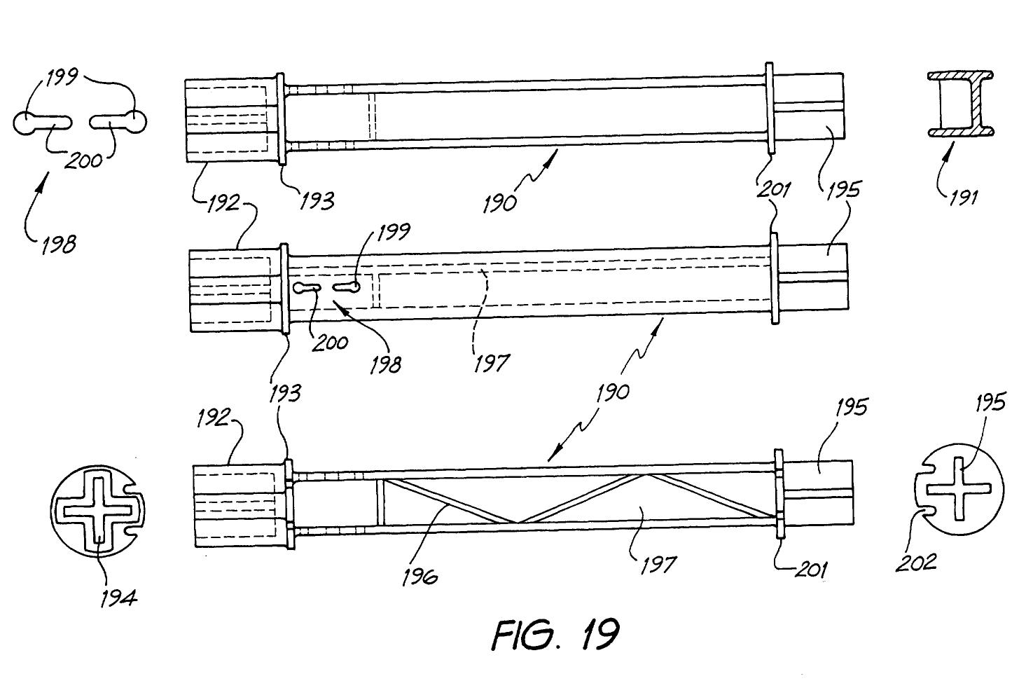

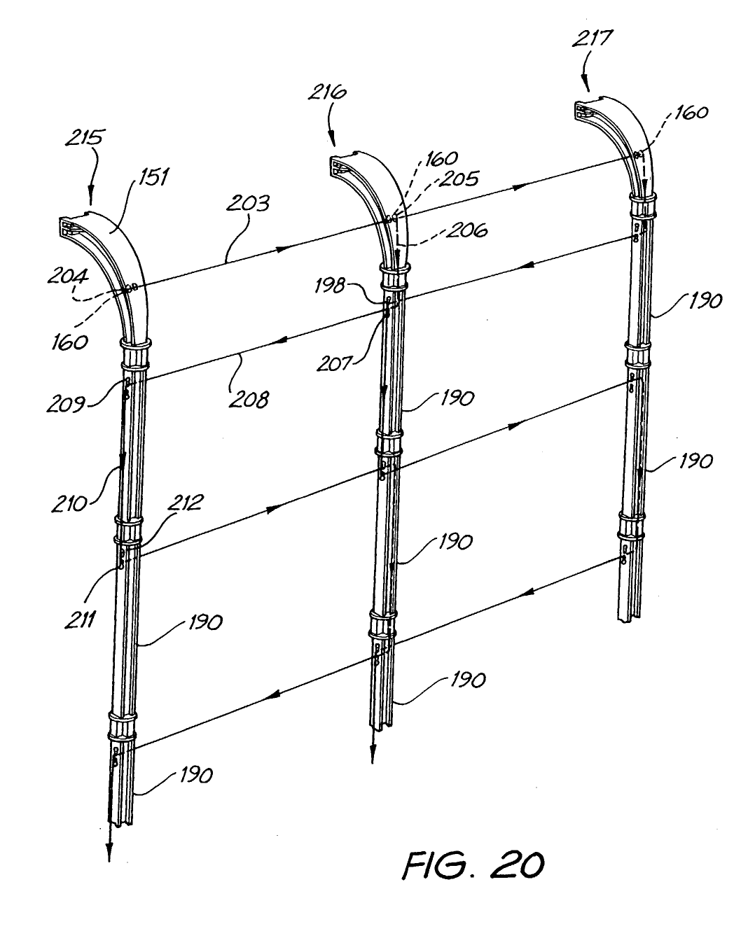

As shown in FIG. 19, the elongated portion may be fabricated from one or more modular sections 190. In this example, each section 190 is generally “I” shaped 191 in cross-section. One end of each section 190 comprises a female member or socket 192 similar to or identical with the socket 183 depicted in FIG. 18. A rim 193 surrounding the socket 192 incorporates one or more slots 194 for facilitating the lacing together of plant supports, as will be explained. The opposite end of each section is formed as a cooperating cruciform male member 195 which is adapted to be received by the sockets 192 or 183. The intermediate portion of each section may be reinforced by ribs 196 as required. The central web 197 of the intermediate portion of the section 190 also incorporates a pair of openings, preferably keyholes 198. Each keyhole in the pair incorporates an enlarged portion 199 at one end of a slot or tapered slot 200. In preferred embodiments, the keyholes 198 are located with the slots 200 adjacent one another and the enlarged portions 199 at each end of the arrangement. The rim 201 also incorporates one or more slots 202 to facilitate lacing.

FIG. 20 illustrates how two or more plant supports of the type shown in FIG. 14 can be laced together. The embodiment depicted in FIGS. 14-20 are particularly well adapted to be laced together utilising a plastic coated metal wire 203. The lacing process begins by attaching the wire 203 to the through opening 204 (160) of a top portion 151. The wire 203 is extended horizontally and introduced through an adjacent through opening 205 (160). After passing through the opening 205, the wire is pulled down 206 to a bottom keyhole 207 of a keyhole pair 198. The wire 203 is then pulled snug and lifted into the slot 200 to lock it in place. The same wire 203 is then extended horizontally 208 to the top keyhole 209 of the first support. The wire 203 is then pulled through the top keyhole 209 and downwardly into the slot 200 wherein it is locked in place. The wire 203 then extends downwardly 210 to the bottom keyhole 211 of a lower pair of keyholes 212 (198). This process is continued until adjacent plant supports 215, 216 are laced together. An additional plant support 217 may be conveniently added to the array simply by repeating the processes described with reference to plant supports 215 and 216. It will be appreciated that the slots 202, 194, allow the wire to pass vertically and behind each plant support in an orderly and convenient way.

Various other modifications may be made in details of design and construction without departing from the scope and ambit of the invention.

1. A plant support adapted to be mounted on a fence post, said support comprising:
a top flange adapted to be mounted on an upper portion of a fence post,
a bottom flange adapted to be mounted on a lower portion of the fence post, and
a support means extending between the bottom flange and the top flange, said support means comprising an elongated portion extending upwardly from the bottom flange and arranged so as to be clear of the fence post when the plant support is mounted on the fence post, and a spacer portion extending from the top flange to the upper end of the elongated portion and arranged so as to extend away from the fence post when the plant support is mounted on the fence post.

2. The plant support of claim 1, wherein:
the spacer is curved.

3. The plant support of claim 1, wherein:
the top and bottom flanges are aligned in a common vertical plane.

4. The plant support of claim 1, wherein:
the elongated portion is formed from identical interlocking plastic sections.

5. The plant support of claim 1, wherein:
the elongated portion has formed in it one or more transverse through holes.

6. The plant support of claim 1, wherein:
the spacer is integral with the top flange.

7. The plant support of claim 1, wherein:
the bottom flange is integral with a foot, the foot having means for receiving the lower end of the elongated portion.

8. The plant support of claim 1, further comprising:
an angle bracket adapted to affix, at one end, to an inner face of the elongated portion, and at another end, to a fence or fence post, vertical wall or surface.

9. The plant support of any one of claims 1 to 8, wherein:
the elongated portion and spacer are integral.

10. The plant support of claim 1, wherein:
each portion has formed in it a pair of adjacent through openings.

11. The plant support of claim 10, wherein:
each of the pair of openings is in the form of a keyhole, each keyhole having an enlarged portion and a slot, the slots facing one another in each pair.

12. The plant support of any one of claim 1 to 8, wherein:
the top flange further comprises a mounting face having ears at either end, the ears defining a gap for receiving the upper portion of the fence post.

13. The plant support of claim 12, further comprising:
a pair of spacers adapted to reside within the gap and between the ears and a post, when in use.

14. The plant support of claim 12, further comprising:
angled through openings at either end of the gap adjacent to the ears.

15. The plant support of claim 1, wherein:
each flange has at least one opening there through.

16. In combination, two or more of the supports of any one of claims 1 to 8, and at least one length of wire or line interconnecting them.

17. The combination of claim 9, wherein:
the or each wire or line is a plastic coated metal wire.
